(19) United States
(12) Patent Application Publication
(10) Pub. No.: US 2006/0182412 A1
(43) Pub. Date: Aug. 17, 2006

(54) Personal video recorder that records through channel change

(76) Inventor: Chad Andrew Lefevre, Indianapolis, IN (US)

Correspondence Address: THOMSON LICENSING INC., PATENT OPERATIONS, PO BOX 5312, PRINCETON, NJ, 08543-5312, US

(21) Appl. No.: 10/565,445

(22) PCT Filed: Jul. 16, 2004
(86) PCT No.: PCT/US04/22954

§ 371 Date: Jan. 20, 2006

Related U.S. Application Data
(60) Provisional application No. 60/488,884, filed on Jul. 21, 2003.

(51) Int. Cl. H04N 5/91

(52) U.S. Cl. 386/65

(57) ABSTRACT

A method and a personal video recorder (400) for time-shifting a presentation of multimedia content using a personal video recorder. A first stream of multimedia content is received on a first channel and stored to a data store (448) associated with the personal video recorder. After a channel change request has been received, a second stream of multimedia content can be received on a second channel correlating to the channel change request. This second content stream can be stored to the data store while retaining the first stream of multimedia content in the data store. During playback and trick mode operation, the multimedia presentation can seamlessly transition between the first and second streams of multimedia content.

### CROSS REFERENCE TO RELATED APPLICATIONS

This application claims the benefit of U.S. Provisional Application Ser. No. 60/488,874 filed on Jul. 21, 2003, the entirety of which is incorporated herein by reference.

### GOVERNMENT RIGHTS IN THIS INVENTION

Not Applicable.

### FIELD OF THE INVENTION

The present invention generally relates to the field of digital video recording, and more particularly to personal video recorders.

### BACKGROUND OF THE INVENTION

Modern day personal video recorders (PVRs) are similar to video cassette recorders (VCRs) in that they allow users to record multimedia presentations and view the presentations on a delayed schedule. Whereas a VCR records multimedia to an analog video tape, a PVR typically records multimedia to a digital data buffer, such as a hard disk drive (HDD). However, the multimedia data is deleted from the PVR data buffer each time a channel change occurs. In consequence, a user cannot rewind into the channel he was watching previous to the channel change. Thus, the ability to time-shift a multimedia presentation is lost in conventional PVR's when a channel change occurs.

### SUMMARY OF THE INVENTION

The present invention relates to a method for time-shifting a presentation of multimedia content using a personal video recorder. A first stream of multimedia content is received on a first channel and stored to a data store associated with the personal video recorder. After a channel change request has been received, a second stream of multimedia content can be received on a second channel correlating to the channel change request. This second content stream can be stored to the data store while retaining the first stream of multimedia content in the data store.

At least one identifier can be assigned to each of the first and second streams of multimedia content to identify a sequence in which the first and second streams of multimedia content are recorded or to identify a channel from which the first and second streams of multimedia content are recorded.

When a rewind trick mode request is received, the second stream of multimedia content can be presented in reverse and the first stream of multimedia content can be presented in reverse after reaching a beginning of the second stream of multimedia content. When a play request is received, the first stream of multimedia content can be presented and the second stream of multimedia content can be presented after reaching an end of the first stream of multimedia content.

The personal video recorder of the invention can include an input port for receiving a first stream of multimedia content on a first channel, a data store for storing the first stream of multimedia content, and a user interface for receiving a channel change request. A processor can change a channel to receive through the input port a second stream of multimedia content on a second channel correlating to the channel change request. The second stream of multimedia content can be stored to the data store while retaining the first stream of multimedia content in the data store. The processor further can assign at least one identifier to each of the first and second streams of multimedia content to identify a sequence in which the first and second streams of multimedia content are recorded or to identify a channel from which the first and second streams of multimedia content are recorded.

The user interface can include a user input device through which a user can choose a user selectable function to perform a desired personal video recorder operation. A video decoder further can be included which can present the second stream of multimedia content in reverse, and then present the first stream of multimedia content in reverse after reaching a beginning of the second stream of multimedia content. Further the video decoder can present the first stream of multimedia content, and then present the second stream of multimedia content after reaching an end of the first stream of multimedia content. The transition between the streams of multimedia content can occur very quickly so the transitions appear seamless.

### BRIEF DESCRIPTION OF THE DRAWINGS

Preferred embodiments of the present invention will be described below in more detail, with reference to the accompanying drawings, in which:

FIG. 1 shows a flow chart for recording multimedia content through a channel change.

FIG. 2 shows a flow chart for presenting multimedia content recorded from multiple channels in reverse play trick mode.

FIG. 3 shows a flow chart for presenting multimedia content recorded from multiple channels in forward play at normal playback speed.

FIG. 4 is a block diagram of a personal video recorder that is useful for understanding the present invention.

### DETAILED DESCRIPTION

The present invention relates to a method and a system for recording and retaining a plurality of streams of multimedia content in a recording device, such as a Personal Video Recorder (PVR), through channel changes. Accordingly, a user who is recording a first stream of multimedia content from a first channel can change to a second channel and, responsive to the channel change, the PVR can begin recording a second stream of multimedia content from the second channel. Meanwhile, the first stream of multimedia content can be retained within a data store. Accordingly, the user still can access the multimedia content recorded from the first channel, even though the channel has changed. Moreover, the user can sequentially play the plurality of streams of multimedia content in the order that the content was recorded or in any other desired playback sequence.

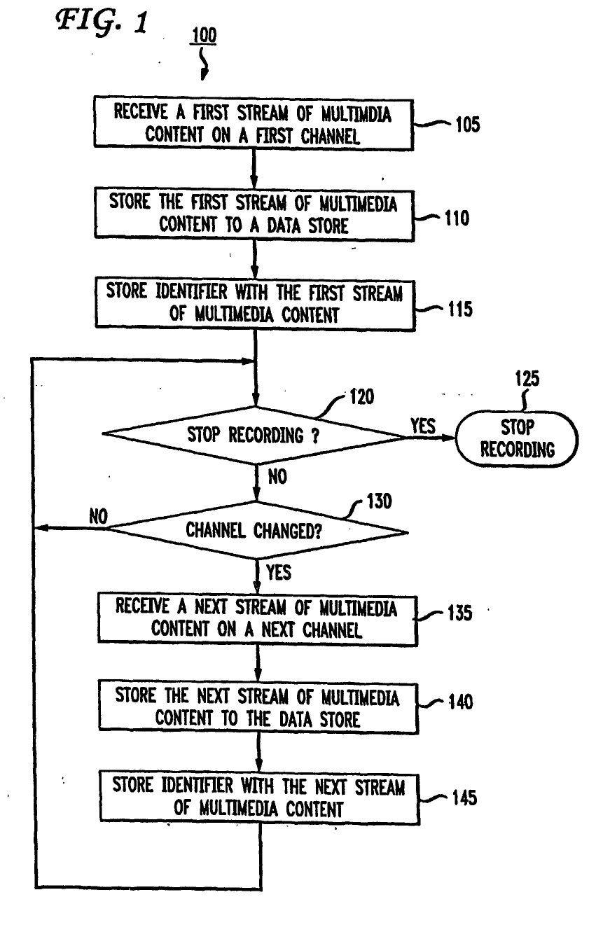

Referring to FIG. 1, a flow chart 100 for recording multimedia content through a channel change is presented. Beginning at step 105, a first stream of multimedia content can be received by the PVR on a first channel. The first stream of multimedia content can be stored to a data store associated with the PVR, as shown in step 110. The data store is discussed in the context of FIG. 4 with greater detail.

Proceeding to step 115, an identifier can be stored with the first stream of multimedia content. For example, the identifier can be a channel identifier. The identifier also can be an identifier, which is used to identify a position of the first stream of multimedia content within a sequence recorded multimedia content streams. For example, the identifier can be a sequential number or a time stamp. Still, the invention is not so limited and the identifier can be any type of identifier that can be assigned to a stream of multimedia content.

Referring to decision box 120 and step 125, if the user wishes to stop recording at this point, the recording can be stopped. However, the recording of the first stream of multimedia content can continue. Continuing to decision box 130, if a channel change request is received the PVR can begin receiving a second stream of multimedia content on a next channel, as shown in step 135. Proceeding to step 140, the second stream of multimedia content from the next channel can be recorded to the data store. Meanwhile, the first stream of multimedia content can be retained in the data store. An identifier can be stored with the second stream of multimedia content, as shown in step 145.

Referring back to decision boxes 120 and 130, the process can continue to record additional streams of multimedia content while further channel changes are made. Thus, any number of streams of multimedia content can be recorded. The process can end when a user chooses to stop recording or a recording timer has timed out.

In one arrangement, the identifiers assigned to the first and second streams can be used to delineate the first and second streams of multimedia content. Alternatively, the PVR can merge two or more streams of multimedia content into a single stream. For instance, the PVR can record the first stream of multimedia content and, when the channel changes, the PVR can continue recording the second stream of multimedia content without providing a delineator between the two streams.

In another arrangement, the PVR can continue recording the first stream of multimedia content while recording the second stream of multimedia content from the next channel. The identifiers recorded with each stream can be used to differentiate the-streams. In this case, an additional identifier can be provided with each stream of multimedia content to identify points in the streams that correlate to the channel change.

In one arrangement, the user can be alerted via the user interface in the instance that the amount of multimedia content that is stored approaches the capacity of the data store. Additionally, recorded multimedia content can be selectively overwritten when the data store capacity is reached. For example, the selection of which multimedia content to overwrite can be determined based upon which multimedia content has the oldest time stamp(s), which multimedia content has been identified as unimportant by a user, or any other desired criteria.

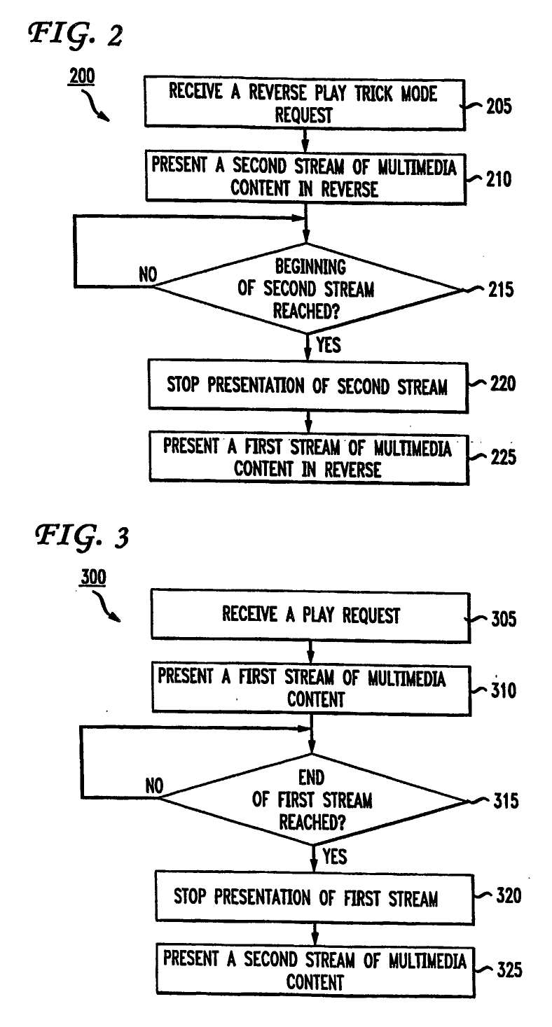

During playback, the PVR can seamlessly transition between the first stream of multimedia content and the second stream at points in each stream correlating to the channel change. For example, FIG. 2 shows a flow chart 200 for presenting multimedia content recorded from multiple channels in reverse play trick mode. Beginning at step 205, a reverse play trick mode request can be received by the PVR and the second stream of multimedia content can be presented in reverse, as shown in step 210. Referring to decision box 215 and step 220, when the beginning of the second stream is reached the PVR can stop presentation of the second stream. Continuing at step 225, the PVR then can present the first data stream in reverse play. Importantly, steps 220 can 225 can be performed rapidly so that the transition between the streams of multimedia content appears instantaneous.

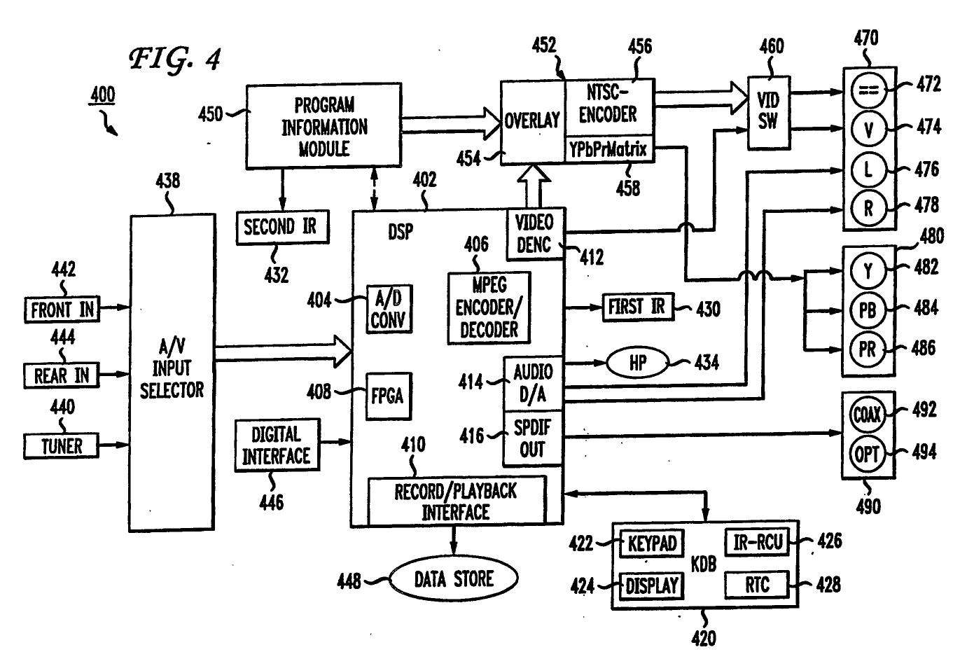

An example of presenting multimedia content recorded from multiple channels in forward play at normal playback speed is shown in FIG. 3. Beginning at step 305, a play request can be received by the PVR and the first stream of multimedia content can be presented at normal playback speed, as shown in step 310. Referring to decision box 315 and step 320, when the end of the first stream is reached the PVR can stop presentation of the first stream. Continuing at step 325, the PVR then can present the second data stream. Again, steps 320 can 325 can be performed rapidly so that the transition between the streams of multimedia content appears instantaneous.

At this point it should be noted that the present invention is not limited to the aforementioned examples. Importantly, any suitable trick modes can be performed using the plurality of recorded streams of multimedia content. In an arrangement where a recording of the first stream of multimedia content continued after the channel change, the identifier identifying the point in the first stream correlating to the channel change can be used to signal playback to switch from the first stream to the second stream. In another arrangement, a visual and/or audio indicator can be provided via a user interface to alert a user at a portion of the first stream correlating to a channel change, which had occurred during recording. The user can be provided with an option to override the channel change during playback.

A block diagram of a PVR 400 incorporating means for recording and retaining a plurality of streams of multimedia content in the PVR through channel changes is shown in FIG. 4. The PVR 400 can include a processor, for example digital signal processor (DSP) 402 or any other suitable processor, a key and display board 420, a tuner 440, an A/V input selector 438, a USB input 446, a storage device 448 and a program information module 450. Additionally, the PVR 400 can include first and second infra-red (IR) links 430 and 432, a video overlay encoder 452, a video switch 460, a headphone jack 434, a standard A/V component connector block 470, a YPbPr component connector block 480, and a Sony/Phillips digital interface (SPDIF) connector block 490.

The component connector blocks 470, 480 and 490 can provide audio/video signals in a variety of output formats. For example, the standard A/V component connector block 470 can comprise an S-video connector 472 for outputting to a video display video that has been separated into chrominance and luminance video signals and a composite video connector 474 for providing a standard composite video signal. Further, the standard A/V component connector block 470 can comprise left and right audio output connectors, 476 and 478, respectively.

The YPbPr component connector block 480 is typically used for high definition television (HDTV). The YPbPr component connector block 480 comprises a video luminance (Y) output connector 482 for providing an analog video luminance component, a Pb output connector 484 for providing an analog blue color difference (B—Y), and a Pr output connector 486 for providing an analog red color difference (R—Y). Lastly, the SPDIF component connector block 490 comprises a coaxial output 492 and an optical output 494 for outputting digital audio signals via a coaxial cable or fiber optic cable, respectively.

The key and display board 420 can be provided as a user interface for the PVR 400. The key and display board 420 can incorporate a keypad 422, a display 424, an IR remote control interface 426 and a real time clock 428. By using the keypad 422 or the IR remote control interface 426, a user can select functions to be executed by the PVR 400 to perform a desired PVR operation. For example, a user can choose to change channels on the PVR 400 or to perform trick mode playback. The real time clock 428 can keep time, which can be shown by the display 424. The display 424 also can show other information as well, for example a trick mode being executed by the PVR 400, a selected channel being recorded by the PVR 400, or an identifier representative of a presentation being shown on a video display.

First and second IR links 430 and 432 form a set of communication links between satellite and non-satellite applications to help simplify the interface between the audio, video, and data streams. The first IR link 430 can be a communication interface between the DSP 402 and other devices having an IR communication link. Notably, the first IR link 430 can be useful for controlling other devices designed specifically for aired or cable television broadcasts or radio broadcasts using standard program guide information. The first IR link 430 also can enable features to simplify the consumer's interaction between devices. For example, the first IR link 430 can enable one touch program recording, as well as other user conveniences. The second IR link 432 can provide an interface between the program information module 450 and other devices having IR communication links. Significantly, the second IR link 432 can be useful for communicating with devices not requiring a direct connection to DSP 402, for example with a cable reception device, a VCR, etc.

The DSP 402 can execute programmed functions and process user inputs. For instance, the DSP 402 can receive user inputs for changing channels and establishing/changing recording parameters. The DSP 402 can comprise an analog to digital (A/D) converter 404, an MPEG encoder/decoder 406, a field programmable gate array (FPGA) 408, a recorder/playback interface 410, a video digital encoder 412, an audio digital to analog converter (audio D/A) 414 and a SPDIF output 416. The DSP 402 can further include one or more data busses enabling the different DSP components to communicate with each other and cooperatively process data. Notably, interrupt requests (IRQs) and direct memory addresses (DMAs) can be utilized to facilitate bus communications and data processing.

Audio/Video (A/V) input selector 438 can include a plurality of A/V inputs. For example, the input selector 438 can incorporate an A/V input to receive streams of multimedia content from tuner 440. For instance, the tuner 440 can include an input port for receiving streams of multimedia content. Importantly, the tuner 440 can be configured to receive a plurality of streams of multimedia content simultaneously over multiple channels.

The input selector also can receive multimedia content from various other input devices as well. For example, a video camera can send multimedia content to the input selector 438 via front A/V input 442, and a VCR can send multimedia content via rear A/V input 444. Significantly, other A/V devices can be connected to the A/V input selector 438 as well.

The A/V input selector 438 can forward the received multimedia content to DSP 402. The DSP's A/D converter 404 can be used to convert multimedia content received in an analog format to a digital format. Multimedia content already in digital format can bypass the analog to digital conversion, for example, multimedia content received via a digital interface 446.

FPGA 408 can provide processing instructions for data received from the A/V input selector 438 or the digital interface 446, depending on the type of data received. For example, if multimedia content is received in an uncompressed form, FPGA 408 can forward the multimedia content to MPEG encoder/decoder 406 for MPEG compression prior to being sent to the record/playback interface 410. However, if multimedia content is received in an MPEG compressed format, FPGA 408 can forward the multimedia content straight to the receive/playback interface 410. In either case the FPGA 408 can provide read/write instructions to the record/playback interface 410, which then can store the multimedia content onto data store 448. The read/write instructions can include instructions for assigning identifiers to the multimedia content. For instance, the instructions can require that a unique identifier be assigned to each stream of multimedia content, that time stamps be assigned to portions of the multimedia content, that points in streams of multimedia content correlating to channel changes be identified, and/or any other suitable identifiers be provided in the recorded multimedia content.

MPEG encoder/decoder 406 can perform MPEG compression and decompression on digital multimedia content. For example, MPEG encoder/decoder 406 can receive digital multimedia content from A/D converter 404 or digital interface 446, compress the digital multimedia content using an MPEG format, and forward the compressed digital multimedia content to the receive/playback interface 410. The receive/playback interface 410 then can store the compressed digital multimedia content to data store 448. The MPEG encoder/decoder 406 can encode the multimedia content with time stamps and/or identifiers. The real time clock 428 can be used to generate time stamps, but the invention is not so limited. For example, a clock internal to the DSP 402 or any other timing device can be used. The identifiers and/or time stamps can be processed by the MPEG encoder/decoder 406 and/or the digital video encoder 412 during playback of the multimedia content, as previously noted.

The data store 448 can include one or more data storage devices. For example, a data storage device can be a magnetic storage medium, such as a hard disk drive (HDD), an optical storage medium, such as a digital video disk (DVD), an electronic storage medium, such as random access memory (RAM), a magneto/optical storage medium, or any other suitable storage device. Moreover, the data store 448 can include any combination of storage devices.

The data store 448 can be connected to the record/playback interface 410 via any suitable communications bus. For example, the data store 410 can be connected to the record/playback interface 410 via an IEEE-1394 bus (FireWire, i.LINK), a universal serial bus (USB), an advanced technology attachment (ATA) bus, a serial ATA (SATA) bus, a peripheral component interconnect (PCI) bus, or any other suitable communications interface.

During playback the receive/playback interface 410 can read multimedia content from data store 448. The multimedia content then can be forwarded to MPEG encoder/decoder 406 for decompression. After decompression the multimedia content can be separated into video and audio signals. The audio signal can be forwarded to SPDIF 416 to be output digitally via coaxial output 492 or optical output 494. The audio signal also can be forwarded to audio D/A converter 414 for D/A conversion. After D/A conversion the audio signal can be output via headphone jack 434 and/or left and right audio outputs 476 and 478.

The video signal can be processed by video digital encoder 412, which can perform D/A conversion on the video signal as well as encode the video signal into a variety formats. For example, the video signal can be encoded into an RGB format, separated into luminance and chrominance (Y+C) signals, or encoded into a composite video signal having a National Television Standards Committee (NTSC) format. The composite video and the Y+C video signals can be forwarded to video switch 460, while the RGB video signal can be forwarded to the video overlay encoder 452.

The video overlay encoder 452 can comprise overlay module 454, NTSC video encoder 456, and YPbPr matrix encoder 458. The overlay module 454 can receive program information from a program information module 450 and graphically overlay the program information onto the video signal. The program information module 450 can extract the program information from a program guide. The program guide can be provided from a myriad of sources. For example, the program guide can be provided from an on-line source, a modem dialup connection, a pager network, etc. The program guide also can be contained in incoming multimedia content received by the A/V input selector 438 and communicated to the program information module 450 by the DSP 402.

The program information can include available programs for each channel as well as program scheduling. Further, for each individual program the program information can include a program identifier, channel information, recording time, program duration, scene data, program credits, etc. Other information and graphics may be overlayed onto the video signal as well. For example, a clock, text blocks, user information, menus, icons, pictures, etc. can be overlayed onto the video signal. Typically, information is overlayed onto the video signal when requested by a user or upon some pre-defined event. However, some information, such as a channel identifier, can be continually overlayed over the video signal.

The NTSC encoder can output the video signal as an NTSC formatted composite video signal, as well as video separated into separate luminance and chrominance signals. The video signals then can be forwarded to the video switch 460. The video switch 460 can be used to select for display either the NTSC encoded video signal or the video signal generated by the video digital encoder 412. Composite video signals from either source can be output via composite video output connector 474, while chrominance and luminance video signals from either source can be output via the S-video output connector 472.

The YPbPr matrix encoder 458 can generate a YPbPr formatted analog video signal. As previously noted, the YPbPr video signal includes a video luminance (Y) component, an analog blue color difference (B—Y), and an analog red color difference (R—Y). The Y component can be output to the Y output connector 482, the (B—Y) difference can be output to the Pb output connector 484 and the (R—Y) difference can be output to the Pr output connector 486.

While the foregoing is directed to the preferred embodiment of the present invention, other and further embodiments of the invention may be devised without departing from the basic scope thereof, and the scope thereof is determined by the claims that follow.

1. method for time-shifting a presentation of multimedia content using a recorder comprising:
receiving a first stream of multimedia content on a first channel;
storing the first stream of multimedia content to a data store associated with the recorder;
receiving a channel change request;
receiving a second stream of multimedia content on a second channel correlating to the channel change request;
storing the second stream of multimedia content to the data store while retaining the first stream of multimedia content in the data store;
receiving a rewind trick mode request;
presenting the second stream of multimedia content in reverse; and
presenting the first stream of multimedia content in reverse after reaching a beginning of the second stream of multimedia content.

2. The method according to claim 1 further comprising assigning at least one identifier to each of the first and second streams of multimedia content to identify a sequence in which the first and second streams of multimedia content are recorded.

3. The method according to claim 1 further comprising assigning at least one identifier to each of the first and second streams of multimedia content to identify a channel from which the first and second streams of multimedia content are recorded.

4. (canceled)

5. The method according to claim 1 further comprising:
receiving a play request;
presenting the first stream of multimedia content; and
presenting the second stream of multimedia content after reaching an end of the first stream of multimedia content.

6. A recorder comprising:
an input port for receiving a first stream of multimedia content on a first channel;
a data store for storing the first stream of multimedia content;
a user interface for receiving a channel change request;
a processor for changing a channel to receive through the input port a second stream of multimedia content on a second channel correlating to the channel change request and storing the second stream of multimedia content to the data store while retaining the first stream of multimedia content in the data store; and
a video decoder that presents the second stream of multimedia content in reverse, then presents the first stream of multimedia content in reverse after reaching a beginning of the second stream of multimedia content.

7. The recorder of claim 6 wherein the processor further assigns at least one identifier to each of the first and second streams of multimedia content to identify a sequence in which the first and second streams of multimedia content are recorded.

8. The recorder of claim 6 wherein the processor further assigns at least one identifier to each of the first and second streams of multimedia content to identify a channel from which the first and second streams of multimedia content are recorded.

9. The recorder of claim 6, said user interface further comprising a user input device through which a user can choose a user selectable function to perform a desired recorder operation.

10. (canceled)

11. The recorder of claim 6 further comprising a video decoder that presents the first stream of multimedia content, then presents the second stream of multimedia content after reaching an end of the first stream of multimedia content.
